(19) United States
(12) Patent Application Publication
(10) Pub. No.: US 2007/0136219 A1
(43) Pub. Date: Jun. 14, 2007

(54) Intelligent multi-agent system by learning engine and method for operating the same

(76) Inventors: Minkyoung Kim, Daejeon (KR); Hyun Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/633,177

(22) Filed: Dec. 4, 2006

(30) Foreign Application Priority Data
Dec. 8, 2005 (KR) 2005-119717
Aug. 14, 2006 (KR) 2006-76669

(51) Int. Cl. G06F 15/18

(52) U.S. Cl. 706/12

(57) ABSTRACT

An intelligent multi-agent system by a learning engine and method for operating the same is provided. In the method, user state information is generated corresponding to a task at a plurality of zone agents. The user state information is received and a user behavior pattern is learned through the learning engine. The behavior pattern learned by the learning engine is outputted in the form of a rule. A task generator generates a task corresponding to the output rule. By the operating method, the present invention can be employed in all applications which intend to provide service suitable for a condition by adapting services positioning at different zones to user's behavior pattern.

### BACKGROUND OF THE INVEITON

1. Field of the Invention

The present invention relates to an intelligent multi-agent system by a learning engine and method for operating the same, and more particularly, to an intelligent multi-agent system by a learning engine that realizes an intelligent multi-agent system by introducing the learning engine to utilize a learned result to the utmost, and method for operating the same.

2. Description of the Related Art

A lot of resources that can be used for the convenience of living exist around us. However, it is very difficult to establish a system that can provide services at an appropriate timing in consideration of the characteristics and advantages of the resources. It is very complicated and has many limitations that a system developer performs all procedures to provide those services. Accordingly, as people obtains knowledge from experiences and learning, a system will be much effective if it can catch a service that a user wishes and provide the service suitable for a condition.

Meanwhile, multi-agent system applications have been researched and developed without any stop so as to maximize efficient usage of resources having different qualities. This multi-agent system has very various applications, such as game, stock market, lifesaving, mars exploration and the like. However, since this multi-agent system is realized in much portions based on users' or developers' explicit and detailed definition, it has a structure which is difficult to cope with a change in a target or condition which may occur whenever. This static structure has a limitation to an environment that changes dynamically.

Thus, it is strongly required that an alternative for processing user condition recognition that changes dynamically, a use plan of this result, a use plan of zone agents for efficiently using various resources existing in different places considering the characteristics of the resources, and an environment information managing plan for managing a continual variation should be provided.

### SUMMARY OF THE INVENTION

Accordingly, the present invention is directed to an intelligent multi-agent system and method for operating the same, which substantially obviates one or more problems due to limitations and disadvantages of the related art.

It is an object of the present invention to provide an intelligent multi-agent system that employs a learning engine to maximize a recognition of a condition which changes dynamically in Ubiquitous environment and thus influences an interaction between various kinds of agents, and a method for operating the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an intelligent multi-agent system by a learning engine, including: a plurality of zone agents existing in each zone, managing user state information and performing a service corresponding to an event occurrence; the learning engine observing and learning a user behavior pattern of each of the zone agents and outputting the learned behavior pattern in the form of a rule; and a task generator generating a task in the zone agent when the rule is newly generated.

The above intelligent multi-agent system may further include an environment agent providing the task generator with environment information of the zone agent such that zone information of the zone agent can be referred. The above intelligent multi-agent system may further include a rule DB provided between the learning engine and the task generator, for storing a rule outputting from the learning engine and an invariable definition rule.

The zone agent may include: an event listener sensing an event generated from the zone agent; a task controller managing a task generated according to a rule of behavior patterns of the learning engine and giving a priority in a user's present selection to perform a control corresponding to the task; state information recording a condition generated from the corresponding zone agent; and a communicator transferring the state information as an input value to the learning engine.

In another aspect of the present invention, there is provided a method for operating an intelligent multi-agent system by a learning engine, the method including the steps of: (a) generating user state information corresponding to a task at a plurality of zone agents; (b) receiving the user state information and learning a user behavior pattern through the learning engine; (c) outputting the behavior pattern learned by the learning engine in the form of a rule; and (d) generating a task corresponding to the output rule at a task generator.

The above method, prior to the step (a), may further comprise the step of providing environment information of the zone agent to the task generator such that the generated task can be applied.

The step (a) may include the steps of sensing an event generated from a corresponding zone agent; managing the task generated according to a rule of the behavior pattern of the learning engine and giving a priority in a user's present selection to perform a control corresponding to the task; recording a condition generated from the corresponding zone agent; and transferring the state information as an input value to the learning engine.

The rule outputted in the step (c) may be stored in a rule DB, and be subject to a management including creation, deletion and modification. Preferably, an invariable definition rule is separately stored in the rule DB.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 schematically illustrates an intelligent multi-agent system according to an embodiment of the present invention;

FIG. 2 is a block diagram showing an interior structure of a zone agent within an intelligent multi-agent system according to an embodiment of the present invention; and

FIG. 3 is a block diagram showing an interior structure of a task defining a learned user conduct rule according to an embodiment of the present invention.

### DETAILED DESCRIPTION OF THE INVENTION

The core of Ubiquitous network is that although usable resources are scattered at different zones, the Ubiquitous network provides data capable of using these resources wherever. In other words, the Ubiquitous network provides an environment in which wanted services can be provided wherever users want. This environment needs to additionally develop many applications, but it is a difficult subject to provide an optimal service suitable for a user's condition. The optimal service includes a meaning “providing service necessary for user whenever and wherever the user wants” on the basis of an exact condition recognition on the user.

Accordingly, the present invention will provide an efficient system structure based on the multi-agent system so as to provide the aforementioned service.

For this purpose, a method for constituting the system in an aspect of the multi-agent will be described, and a technical processing procedure for performing task according to condition information acquired from various external sensors and resources will be described.

Reference will now be made in detail to the preferred embodiments of the present invention, examples of which are illustrated in the accompanying drawings.

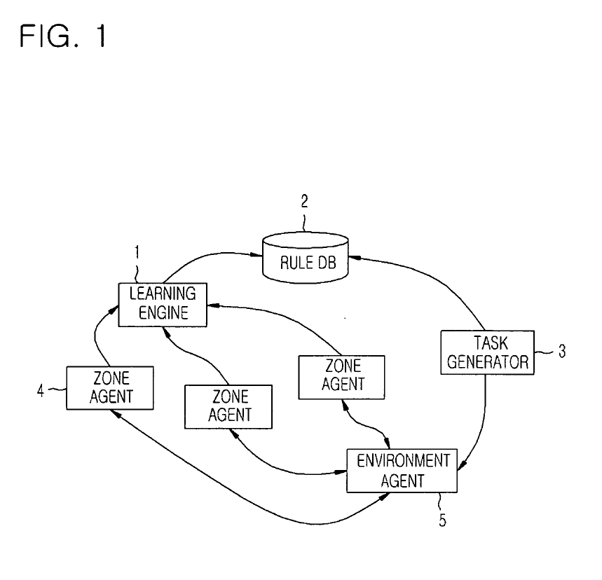

FIG. 1 schematically illustrates an intelligent multi-agent system according to an embodiment of the present invention.

Since users' tastes or behavior patterns are always changes, it is inefficient and impossible for a developer to expect such changes and directly write all tasks. In order to be “service together with me whenever, wherever”, it is most important to exactly catch the users' conditions. For this purpose, an intelligent multi-agent system based on a learning engine 1 that can observe and learn a user's behavior pattern is provided as shown in FIG. 1. This learning engine 1 outputs results in the form of rule through a learned behavior pattern. For example, “if a user name is HONG gil-dong and temperature is above 27° C., then an air conditioner is operated for air cooling.” is stored in a rule database (DB) 2 in the form of rule, and is updated. When a new rule is added in the rule DB 3, a task generator 3 automatically generates tasks in all zones with reference to zone information in an environment agent 5. A zone agent 4 existing in each zone manages environment information in the zone under control and present user state information, and executes a proper service when an event occurs. Likewise, if a rule stored in the rule DB 2 is changed or deleted, the task generator 3 reflects such a fact on the rule DB 2. That is, the task generated in a previous stage is deleted or changed.

Additionally, there can be predictable solution under circumstances, such as, fire, burglary occurrence, or the like. For example, when a fire is generated, a gas valve is closed, and when a burglary is generated, alarm rings or a phone call is connected to a police station or the like. In these cases, it is possible to additionally make a rule defined by a developer or user in the rule DB 2 of FIG. 1. This is to establish a flexible system that can recognize all possible circumstances.

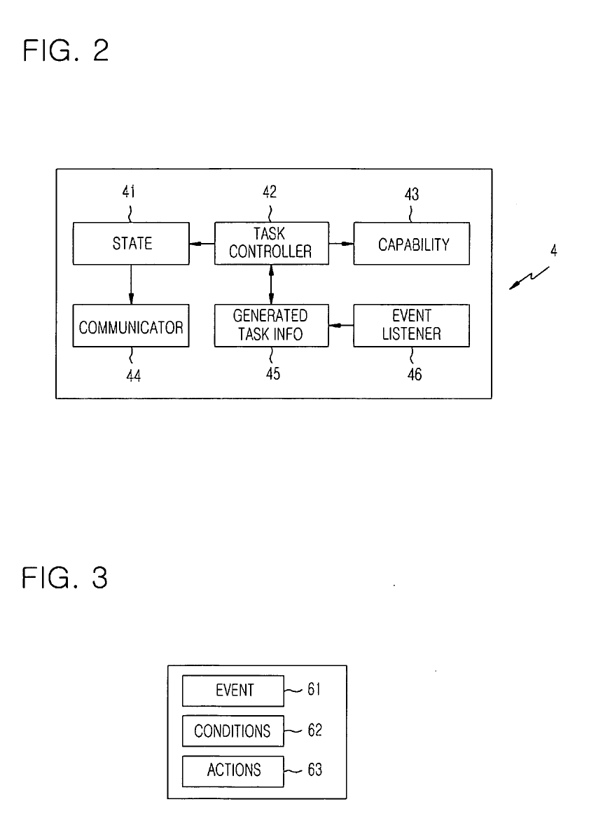

FIG. 2 is a block diagram showing an interior structure of a zone agent within an intelligent multi-agent system according to an embodiment of the present invention.

All environment can be divided into small units of zone. In the present invention, a single zone agent is located in each of the divided zones to perform autonomic work. One or more zone agents form a community, which is an object that exchanges necessary information with one another or interacts between the respective agents along with an autonomous policy decision, like various communities existing in real world.

The works performed by the zone agents can be generally divided into two: First is that when a user gives a command directly according to his or hers will, the zone agent manages the state information at that time. For example, when a user performs behaviors to operate an air conditioner for ventilation even in a room temperature which it is not hot, or to turn an audio of a living room on, the zone agent records all the present circumstances in a state 41 and a communicator 44 transfers this fact as an input value to the intelligent learning engine 1 of FIG. 1. On the basis of these input values, the learning engine 1 continues to learn the user behavior pattern and updates the rule DB 2; second is that when task generator 3 automatically generates a task on the basis of the content of the rule DB 2 which is a set of the behavior pattern rules obtained as a result of the learning engine 1 of FIG. 1, the zone agent 4 manages the tasks generated thus.

The task controller 42 of FIG. 2 obtains which usable services the zone agent 4 can provide, through capability 43. The capability 43 can be referred to as a list of services that can be provided by the zone agent 4. Therefore, if a service is not described in the capability 43, it is impossible to provide a service, and accordingly the task controller 2 makes a policy decision suitable for this. Also, the work pattern of the tasks generated by the task generator 3 is in conflict with the services provided by the present zone agent. For example, it is assumed that the work of the task generated in each zone is to operate the air conditioner when it is above a predetermined temperature. However, if a user in a zone turns off the air conditioner owing to a not-known reason, the decision selected by the present user has a priority. In other words, the task controller 42 of FIG. 2 stops performance of the zone task generated by the task generator 3 of FIG. 1 while the user stays at the present position. Also, the task generated in each zone by the task generator 3 of FIG. 1 senses that a corresponding event has been generated through an event listener 46 and performs a work described in a generated task information 45.

FIG. 3 is a block diagram showing an interior structure of a task defining a learned user conduct rule according to an embodiment of the present invention

The task generated by the task generator 3 of FIG. 1 has an inner structure comprised of an event 61, conditions 62 and actions 63 as shown in FIG. 3. The event 61 indicates a timing when a specific event is generated, the conditions 62 indicate conditions which should be satisfied at the timing when the event 61 has been generated. If the event 61 and the conditions 62 are all satisfied, the services corresponding to the actions 63 are provided. This structure of the task is similar to the learning result pattern through the learning engine 1 of FIG. 1. Accordingly, it is easy that the task generator 3 of FIG. 1 automatically generates the rules described in the rule DB 2 as the task structure of FIG. 3.

As described above, the intelligent multi-agent system by the learning engine and method of operating the same according to the present invention have the following effects:

1. Since the task is automatically generated as a learning result by the intelligent learning system, it is not necessary that a developer describes the detailed content of the task. Also, since the content of the task is not fixed, it is possible to provide a service suitable for a dynamically changed condition.

2. Since each zone agent is in charge of the task control, a performance speed can be enhanced compared with the central processing method, and a system computing overhead can be decreased; and

3. Since the developer can directly add unchanged, i.e., predictable task rule to the rule DB 2 of FIG. 1, it is possible to establish a flexible system serviceable under any condition.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An intelligent multi-agent system by a learning engine, comprising:
a plurality of zone agents existing in each zone, managing user state information and performing a service corresponding to an event occurrence;
the learning engine observing and learning a user behavior pattern of each of the zone agents and outputting the learned behavior pattern in the form of a rule; and
a task generator generating a task in the zone agent when the rule is newly generated.

2. The intelligent multi-agent system of claim 1, further comprising an environment agent providing the task generator with environment information of the zone agent such that zone information of the zone agent can be referred.

3. The intelligent multi-agent system of claim 1, further comprising a rule DB provided between the learning engine and the task generator, for storing a rule outputting from the learning engine and an invariable definition rule.

4. The intelligent multi-agent system of any of claims 1 to 3, wherein the zone agent comprises:
an event listener sensing an event generated from the zone agent;
a task controller managing a task generated according to a rule of behavior patterns of the learning engine and giving a priority in a user's present selection to perform a control corresponding to the task;
state information recording a condition generated from the corresponding zone agent; and
a communicator transferring the state information as an input value to the learning engine.

5. The intelligent multi-agent system of claim 4, wherein the task comprises:
an event setting a timing when the event is generated;
a condition setting a condition which should be satisfied at the time when the event is generated; and
an action setting a corresponding service performance if the event and the condition are all satisfied.

6. A method for operating an intelligent multi-agent system by a learning engine, the method comprising the steps of:
(a) generating user state information corresponding to a task at a plurality of zone agents;
(b) receiving the user state information and learning a user behavior pattern through the learning engine;
(c) outputting the behavior pattern learned by the learning engine in the form of a rule; and
(d) generating a task corresponding to the output rule at a task generator.

7. The method of claim 6, prior to the step (a), further comprising the step of providing environment information of the zone agent to the task generator such that the generated task can be applied.

8. The method of claim 6 or 7, wherein the step (a) comprises the steps of:
sensing an event generated from a corresponding zone agent;
managing the task generated according to a rule of the behavior pattern of the learning engine and giving a priority in a user's present selection to perform a control corresponding to the task;
recording a condition generated from the corresponding zone agent; and
transferring the state information as an input value to the learning engine.

9. The method of claim 6, wherein the rule outputted in the step (c) is stored in a rule DB, and is subject to a management including creation, deletion and modification.

10. The method of claim 9, wherein an invariable definition rule is separately stored in the rule DB.
